(19) United States
(12) Patent Application Publication
(10) Pub. No.: US 2022/0182094 A1
(43) Pub. Date: Jun. 9, 2022

(54) FLEXIBLE HANDLE ASSEMBLY FOR USE WITH PORTABLE ELECTRONIC DEVICES

(71) Applicant: BANDIT, Boca Raton, FL (US)

(72) Inventors: Kerry HOFFMAN, Boca Raton, FL (US); Justin MATHESON, Jupiter, FL (US)

(21) Appl. No.: 17/682,301

(22) Filed: Feb. 28, 2022

Related U.S. Application Data
(63) Continuation of application No. 17/085,665, filed on Oct. 30, 2020.

(51) Int. Cl. H04B 1/3827; H04B 1/3888

(52) U.S. Cl. CPC H04B 1/385; H04B 2001/3861; H04B 1/3888

(57) ABSTRACT

A flexible handle assembly for holding a portable electronic device includes a ring-shaped ferromagnetic base mount (2212) with a ring-shaped magnet base (2220) with at least one arcuate portion (2222, 2224, 2236, 2238) with a set of two or more base magnets (2226, 2228) disposed therein, for magnetically coupling with a portion (2214 or 2216) of the ring-shaped ferromagnetic base mount (2212). The assembly also includes a flexible strap assembly (2240) with a first arcuate end (2242, 2250) with a first set of two or more magnets disposed (2242) therein for magnetically coupling with a portion (2230) of the ring-shaped magnetic base (2220) and a second arcuate end (2244, 2252) with a second set of two or more magnets (2248) disposed therein, for magnetically coupling with another portion (2232) of the ring-shaped magnetic base (2220), and a flexible strap (2264) with a first end (2260) fastened to the first arcuate end (2242, 2250) and a second end (2262) fastened to the second arcuate end (2244, 2252).

### CROSS-REFERENCE TO RELATED APPLICATIONS

This patent application is based on and claims priority from U.S. patent application Ser. No. 17/085,665 filed on Oct. 30, 2020, which is based on and claims priority from U.S. Provisional Patent Application No. 62/927,729, filed on Oct. 30, 2020, each of these prior applications are hereby incorporated by reference in their entirety.

### BACKGROUND OF THE INVENTION

The present invention generally relates to accessories for portable electronic devices and more particularly relates to a detachable handle accessory for portable electronic devices.

Handheld or portable electronic devices, such as mobile phones, tablets, phablets, come in a variety of shapes and sizes. With these and other devices, there is often a need for two hands to complete a task on a device (e.g., texting using a mobile phone). Many times, it is inconvenient to use two hands and/or the user may prefer or desire to use only a single hand when operating the device.

While various gripping handheld electronic devices have been devised (e.g., non-slip surface cases, finger loops, PopSockets®, kickstand-type arms), problems associated with single-handed handling of the handheld electronic device have not been fully resolved.

### SUMMARY OF THE INVENTION

Disclosed is a new novel flexible handle assembly for holding a portable electronic device. The assembly includes a flexible strap with a first end with a first cavity and a second end with a second cavity. The assembly further includes a first magnet disposed in the first cavity and a second magnet disposed in a second cavity. The magnets may be disk-shaped. In one example, a set of a first cap and a second cap is placed over the magnets to secure it into the respective cavities of the flexible strap.

The assembly also includes a base for attaching to a handheld electronic device, the base includes a pattern of separate lines of ferrous material disposed therein.

In one example, the pattern of separate lines is formed so that each of the separate lines are non-overlapping and non-intersecting with any other of the separate lines and the first magnet and the second magnet of the flexible strap is magnetically secured to the base. One such pattern is separate lines formed as substantially parallel lines, for example, concentric circles.

In another example, the flexible strap further comprises a band with a first end with a first opening and a second end with a second opening, and a first spring-loaded pin placed inside the first opening for joining the band to the first end of the flexible strap and a second spring-loaded pin placed inside the second opening for joining the band to the second end of the flexible strap. The flexible strap is one of substantially barbell-shaped or figure-eight shape.

In another example, the handheld electronic device holding apparatus comprising three major components of 1) a ring-shaped ferromagnetic base mount; 2) a ring-shaped magnet base, and 3) a flexible strap assembly. The ring-shaped magnet base includes at least one arcuate portion with a set of two or more base magnets disposed therein, for magnetically coupling with a portion of the ring-shaped ferromagnetic base mount. The arcuate portion of the ring-shaped magnet base may be formed from a bottom plastic portion and a top plastic portion with the base magnets disposed therebetween.

The flexible strap assembly includes a first arcuate end with a first set of two or more magnets disposed therein for magnetically coupling with a portion of the ring-shaped magnetic base and a second arcuate end with a second set of two or more magnets disposed therein, for magnetically coupling with another portion of the ring-shaped magnetic base, and a flexible strap with a first end fastened to the first arcuate end and a second send fastened to the second arcuate end. The first arcuate end of the flexible strap assembly may be formed from a bottom plastic portion and a top plastic portion with the first set of magnets disposed therebetween. Likewise, the second arcuate end of the flexible strap assembly is formed from a bottom plastic portion and a top plastic portion with the second set of magnets disposed therebetween.

In one example, the ring-shaped magnet base further includes a first arcuate portion with a set of two or more base magnets disposed therein, and a second arcuate portion with a set of two or more base magnets disposed therein, and wherein the first arcuate portion and the second arcuate portion are joined together with a set of two ferromagnetic portions to form the ring-shape magnetic base.

In one example, the magnets are positioned in an alternating magnetic pole pattern. The magnets maybe disk-shaped magnets, cylindrical-shaped magnets, or a combination of both. The magnets may include groups of a plurality of magnets stacked one-on-top of another so that a first magnetic pole type of one of the stacked magnets sits on top of a second magnetic pole type of another of the stacked magnets. The magnets may be positioned in an alternating magnetic pole pattern.

### BRIEF DESCRIPTION OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a perspective view of a detached flexible handle assembly for use with portable electronic devices;

FIG. 2 is an exploded view of FIG. 1;

FIG. 3 is a bottom view of FIG. 1;

FIG. 4 is a top view of FIG. 1;

FIG. 5 is an end view of FIG. 1 in which the design from each side are identical or a mirror image thereof;

FIG. 6 is a side view of FIG. 1 in which the design from each side are identical or a mirror image thereof;

FIG. 7 is an exploded perspective view of the ferrous portion of FIG. 1;

FIG. 8 is a perspective view of an attached flexible handle assembly for use with portable electronic devices;

FIG. 9 is a perspective view of an attached flexible handle assembly for use with portable electronic devices of FIG. 8 illustrating the flexed strap;

FIG. 10 is a perspective view of an attached flexible handle assembly for use with portable electronic devices of FIG. 9 illustrating the flexed strap with a user's finger(s) being inserted;

FIG. 11 is an exploded view of FIG. 1 of another embodiment with a removable base plate with ferrous material;

FIG. 12 is a top view of another embodiment of a base for use with portable electronic devices that have magnetics;

FIG. 13 is an end view of a base of FIG. 12;

FIG. 14 is an end view of a base plate of FIG. 12;

FIG. 15 is a perspective view of FIG. 14;

FIG. 16 is a side view of the base of FIG. 12;

FIG. 17 is a side view of the base plate of FIG. 14;

FIG. 18 is a top view of another embodiment of a handle assembly;

FIG. 19 is a cross-section side view of FIG. 18;

FIG. 20 is a perspective view of flexible band of FIG. 18;

FIG. 21 is a base of FIG. 18;

FIG. 22 is an exploded view of another embodiment of a handle assembly:

FIG. 23 is a reduced exploded view of FIG. 22, illustrating three major components;

FIG. 24 is an assembled view of FIG. 22, with the badge in a lower position;

FIG. 25 is a reduced exploded view of FIG. 22, illustrating three major components with a badge in an upper position;

FIG. 26 is an assembled view of FIG. 22, with the badge in an upper position;

FIG. 27 a perspective view of the handle assembly with the badge in a top position;

FIG. 28 a front elevational view thereof with the badge in the top position;

FIG. 29 a back elevational view thereof with the badge in the top position;

FIG. 30 is a right elevational view thereof, with the badge in the top position which is a mirror image to a left elevational view thereof;

FIG. 31 is a top plan view thereof, with the badge in the top position, which is a mirror image to a bottom plan view thereof;

FIG. 32 is a right elevational view thereof, with the badge in the top position, which is a mirror image to a left elevational view thereof without the portable electronic device;

FIG. 33 is a front elevational view thereof, with the badge in the top position, which is a mirror image to a left elevational view thereof without the portable electronic device;

FIG. 34 is a perspective view thereof, with the badge in the top position without the portable electronic device

FIG. 35 is a top elevational view thereof, with the badge in the top position, which is a mirror image to a left elevational view thereof without the portable electronic device;

FIG. 36 a perspective view of the handle assembly with the badge in a bottom position;

FIG. 37 is a right elevational view thereof, with the badge in the bottom position, which is a mirror image to a left elevational view thereof without the portable electronic device;

FIG. 38 is a front elevational view thereof, with the badge in the bottom position, which is a mirror image to a left elevational view thereof without the portable electronic device;

FIG. 39 is a perspective view thereof, with the badge in the bottom position without the portable electronic device; and

FIG. 40 is a top elevational view thereof, with the badge in the bottom position which is a mirror image to a left elevational view thereof without the portable electronic device.

Broken lines shown in the figures form no part of the claimed design.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure and function. Further, the terms and phrases used herein are not intended to be limiting; but rather to provide an understandable description of the invention.

The terms “a” or “an”, as used herein, are defined as one or more than one. The term plurality, as used herein, is defined as two or more than two. The term another, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term fastening means includes soldering, brazing, welding, glue, epoxy, and mechanical fasters such as bolts, screws and riveting or any combination thereof.

### Overall Structure and Components of Releasably Attached Handle

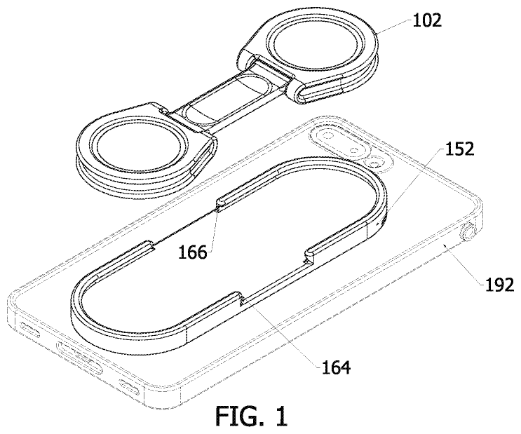

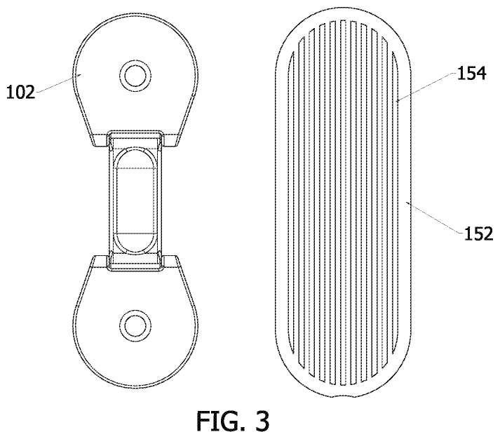

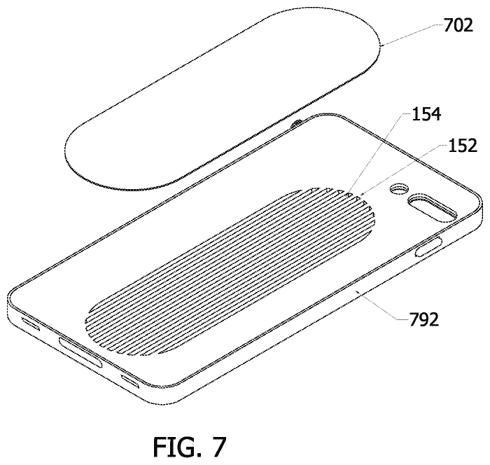

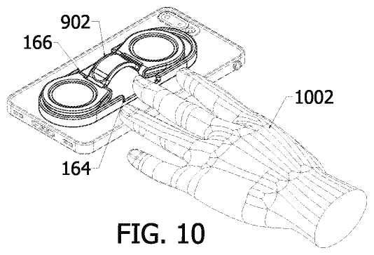

The present invention provides the ability to releasably attached handle for a portable electronic device. Turning now to FIG. 1 is a perspective view of a detached flexible handle assembly for use with a portable electronic device. There are two main components to the flexible handle assembly. A base 152 is attached to the back of a handheld electronic device 192 and a flexible magnetic strap assembly 102. An optional finger recess 164 is also shown. This will be described further with reference to FIG. 10 below. The base 152 may also be integrated into an aftermarket handheld electronic device case. The base 152, as shown in FIG. 3 and FIG. 7, includes an open ferrous material pattern 154. Ferrous materials are magnetic. The ferrous materials typically contain iron, such as steel, stainless, carbon steel, cast iron, and other metals. One example of ferrous materials that has been shown to be used advantageously with the present invention is a permanent magnet made from neodymium magnet material. Other types of permanent magnets that are applicable are magnetic metallic elements, rare-earth magnets, composite magnets, nano-structured magnets or a combination thereof.

In one example, the pattern of this magnetic material consists of parallel lines, concentric lines, concentric circles, or a combination thereof that do not overlap, do not intersect, and are not electrically connected to each other. Stated differently, each of the lines in the pattern is isolated from every other line in the pattern. Details of these open ferrous material patterns are illustrated in FIG. 7. Shown in FIG. 7 is an aftermarket smartphone case 792, showing the base 152 with open ferrous material pattern 154 and non-metallic cover 702.

Unlike various gripping devices, the present invention does not prevent the use of wireless charging because of the base elements design. More specifically, the inventors discovered this pattern of magnetic material reduces interference of electromagnetic interference when the base 152 is used with through-surface wireless charging of the handheld electronic device 192.

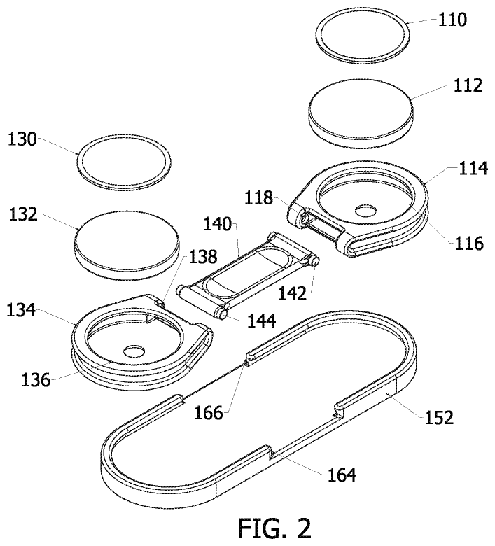

Turning to FIG. 2 is an exploded perspective view of a detached flexible handle assembly for use with portable electronic devices. The flexible magnetic strap assembly 102 is symmetrical from the middle with two ends 114, 134. Each end 114, 134 includes openings 116, 136 to receive magnets 112, 132 respectively. In one example, the magnets 112, 132 are disk-shaped, but other shapes are also possible. A substantially inverted U-shape caps, badges or covers 110, 130 are adapted to cover the magnet 112, 132 in each cavity or opening 116, 136. The cover 110, 130 includes an outer ring and a center portion, typically made of clear plastic that does not block or reduce the magnetic field. In another example, the magnets 112, 132 are directly molded into each end 114, 134.

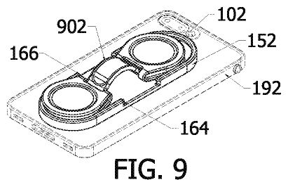

The flexible magnetic strap assembly 140, like a watch strap, can be made of any flexible organic or inorganic material, including rubber, plastic, leather, or a combination thereof. In one example, like a watchband, each end of the flexible magnetic strap assembly 140 includes two ends with pressure or spring-loaded pins 142, 144. The ends of each of the pressure pin 142, 144 engage a pair of holes 118, 138 formed in ends 114, 134. This attachment, combined with the band's flexibility, enables the flexible magnetic strap assembly 102 to create an adjustable loop with an opening 902 (in FIG. 9 and FIG. 10) between the flexible magnetic strap assembly 102 and the base 152.

In another example, instead of the spring-loaded pins 142, 144 are made from plastic. The two ends 114, 134 are formed from deformable rubber. The use of deformable rubber allows the user to squeeze each end 114, 134, while the magnets 112, 132 and cap 130 and 110 are removed, thereby expanding the distance between the pair of holes 118 at end 114 and holes 138 and end 134. This expansion of the distance enables the plastic pin to be removed.

In still another example, like a band used on an Apple® Watch, the flexible magnetic strap assembly 140 can be made to slide in and out of a groove (not shown) formed on each end 114, 134.

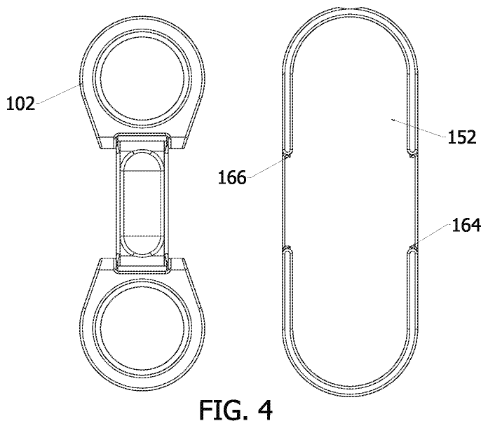

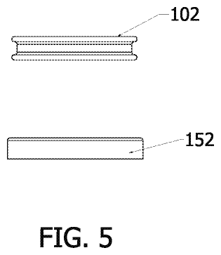

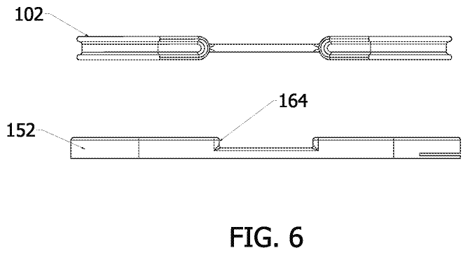

Turning now to FIG. 3 is a bottom view of FIG. 1. Shown are the two main components. A base 152 is attached to a back of a handheld electronic device 192 and the flexible magnetic strap assembly 102. The base 152 illustrates one example of an open ferrous material pattern 154 consisting of parallel lines that are not electrically connected. FIG. 4 is a top view of FIG. 1. FIG. 5 is an end view of FIG. 1 in which the design from each side is identical or a mirror image. Likewise, FIG. 6 is a side view of FIG. 1 in which the design from each side is identical or a mirror image.

FIG. 7 is an exploded perspective view of the ferrous portion of FIG. 1. Shown is an aftermarket smartphone case 792, showing the base 152 with open ferrous material pattern 154 and non-metallic cover 702.

It is important to note that the base 152 may be integrated in a case for a portable electronic device or place using adhesive on one side attached to the case (not shown) or adhesive tape, such as 3M® double-sided tape, which comes in various adhesive strengths for permanent bonding and semi-permanent applications.

Lastly, for certain portable electronic devices such as the Lenovo MotoZ® series and the Apple iPhone® 12 series with ferrous material or ferromagnetic as integrated directly into the casting. The present invention works with these features as well. In this example, the base 152 may be eliminated. The magnets 112, 132 in the flexible magnetic strap assembly 140 will work with the magnets on in the phone's casting (not shown).

### Operation and Example Use of Releasably Attached Handle

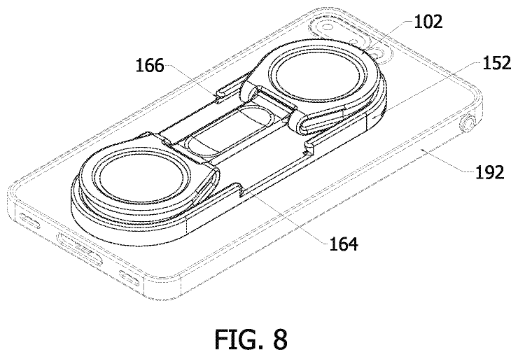

Turning now to FIG. 8 is a perspective view of an attached flexible handle assembly for use with portable electronic devices. Shown are the two main components: a base 152 attached to a back of a portable electronic device. The open ferrous pattern 154 disposed in the base 152 is magnetically coupled to magnets 112, 132 of FIG. 2. Note that the flexible magnetic strap assembly 140 is substantially flat against the base 152, as shown.

FIG. 9 is a perspective view of an attached flexible handle assembly for use with portable electronic devices of FIG. 8, illustrating the flexible magnetic strap assembly 140 being flexed, forming an opening 902. Note that the size of the opening 902 can be adjusted to be larger by moving the ends 114, 134 towards each other. Likewise, the opening 902 can be made smaller by moving the ends 114, 134 further apart.

FIG. 10 is a perspective view of an attached flexible handle assembly for use with portable electronic devices of FIG. 9, illustrating the handle being flexed with a user's finger(s) 1002 being inserted into the opening 902 according to one example of the invention.

It is important to note that although fingers are shown to be inserted into opening 902 that opening 902 can be formed around other items such as a rail on a grocery shopping cart, a mount for a car or boat or desk, or any other structure capable of being held within the opening 902.

When the flexible magnetic flexible band 102 is flat against the base 152, the optional finger recess 164, 166 makes it easier for a user to pull the flexible magnetic flexible band 102 away from the base 152.

### Customizations of Strap and Covers

The present invention allows customization of the flexible magnetic strap assembly 140 and/or cap or cover 110, 130 of FIG. 2. Customizations include materials, colors, graphics, logos, advertisements, or a combination of these, in which the user can mix and match.

### Removable Base Plate Example

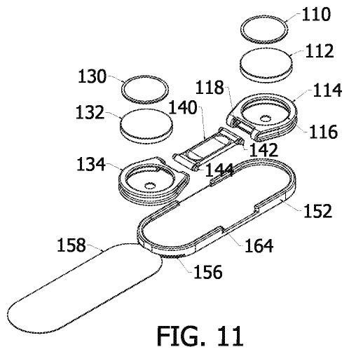

FIG. 11 is an exploded view of FIG. 1 of another embodiment with a removable base plate 158 with ferrous material. In this embodiment, the base plate 158, which includes an open ferrous material pattern 154 as described above, is slidable into a set of channels or grooves 156 formed in a side of the base 152 as shown. Although the grooves 156 are formed on one end, the grooves may be formed on any side of the base 152. In this example, with the base plate 158 removable, any ferrous pattern (not shown) may be used. Also, the base-plate 158 may be made from a ferrous metal to enable wireless charging when removed from the base 152.

First Example of Flexible Handle Assembly for Portable Electronic Device with Circular Magnets

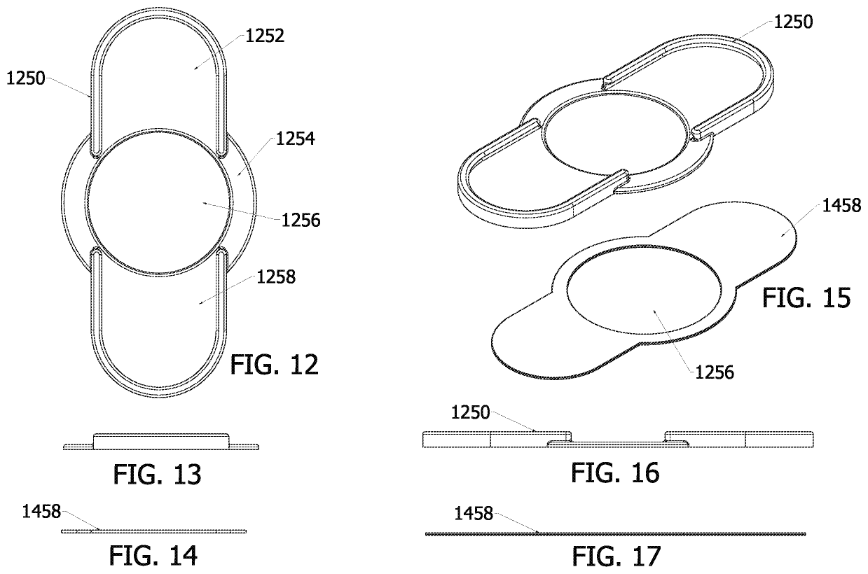

FIG. 12 is a top view of another embodiment of a base for use with portable electronic devices. In this example, the base is adapted to be used with a portable electronic device that have magnets integrated in the casting. Magnets integrated with the casting of the portable electronic device itself is different than aftermarket covers or cases. Examples of portable electronic devices with built-in magnets include the Lenovo MotoZ® series and the Apple iPhone® 12 series with ferrous material or ferromagnetic as integrated directly into the casting. In this example, the base 1250 includes a first end 1252 and a second end 1258. Each of the first end 1252 and the second end 1258 are joined by a semicircular center portion 1254 as shown. The semicircular center portion 1254 has an opening 1256. The opening 1256 allows the built-in magnets of the portable electronic device casting to still be used with other accessories such as wireless chargers.

The opening 1256 may include plastic or non-ferrous caps or covers (not show) that do not block the magnetic field. These covers could be customized with colors, graphics, logos, advertisements, or a combination of these in which the user can mix and match.

The remaining figures in this example are now briefly described. FIG. 13 is an end view of a base 1250 of FIG. 12, and FIG. 14 is an end view of a base plate 1458 of FIG. 12. The base plate 1458 can either be formed within the base 1250 or attached with adhesive. Continuing further, FIG. 15 is a perspective view of FIG. 14 and FIG. 16 is a side view of the base 1250 of FIG. 12. Finally, FIG. 17 is a side view of the base plate 1458 of FIG. 14.

Second Example of Flexible Handle Assembly for Portable Electronic Device with Circular Magnets

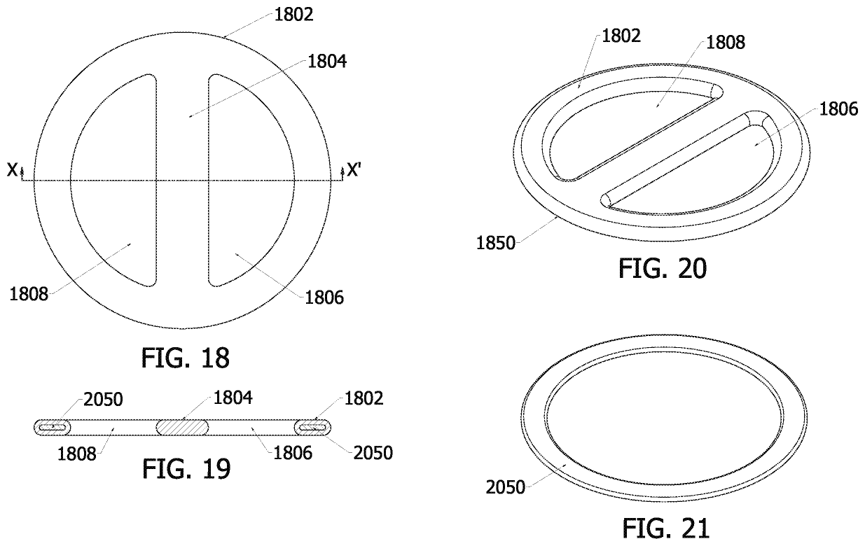

Turning now to FIG. 18 is a top view of another embodiment of a handle assembly. In this example, an oval shape 1802 is shown. The oval shape 1802 includes at least one center rib 1804 that defines two open portions 1806, 1808. Other ribs may be included in another example. FIG. 19 is a cross-section side view along X-X′ of FIG. 18 showing a metallic or ferrous ring 2050 of FIG. 21. FIG. 20 is a perspective view of the flexible band of FIG. 18. The rib 1804 is flexible enough to allow a user to put a finger or fingers through to grasp the portable electronic device when attached. The rib is made formed from the same material as oval shape 1802 or some other material. These materials include rubber, plastic, leather, or other organic or inorganic materials.

FIG. 21 is a perspective view of a metallic or ferrous ring 2050 of FIG. 18. The ferrous ring 2050 may be incorporated as part of the molding process directly inside the oval shape 1802. In another example, the ferrous ring 2050 is attached to the bottom 1850 of the oval shape 1802 using adhesive. The ferrous ring 2050 is sized and designed to magnetically couple to with ferrous material or ferromagnetic as integrated directly into the casting of the portable electronic device (not shown).

### Third Example of Flexible Handle Assembly for Portable Electronic Device

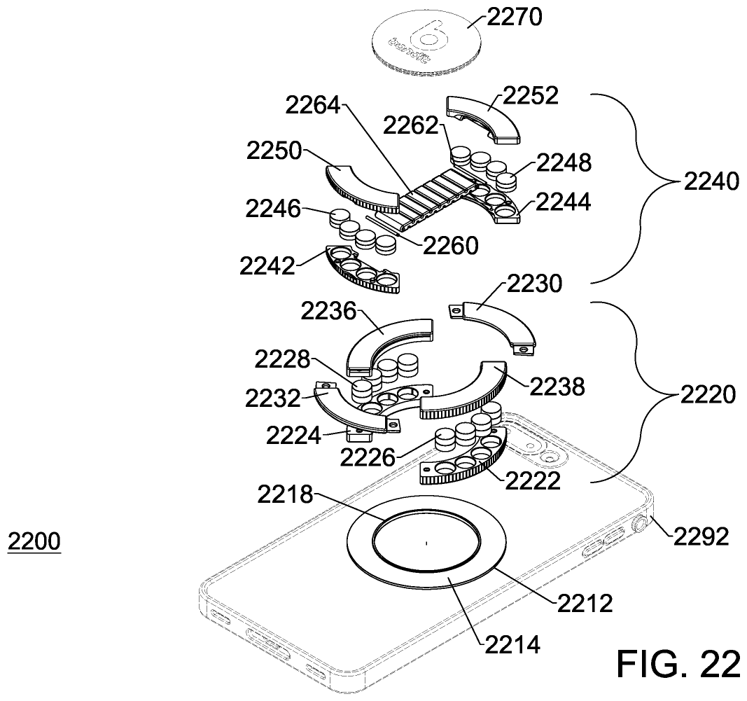

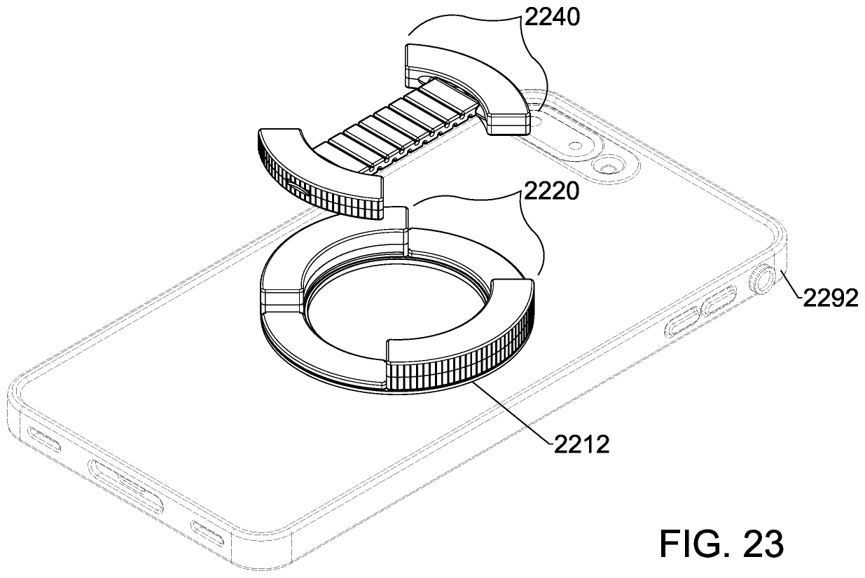

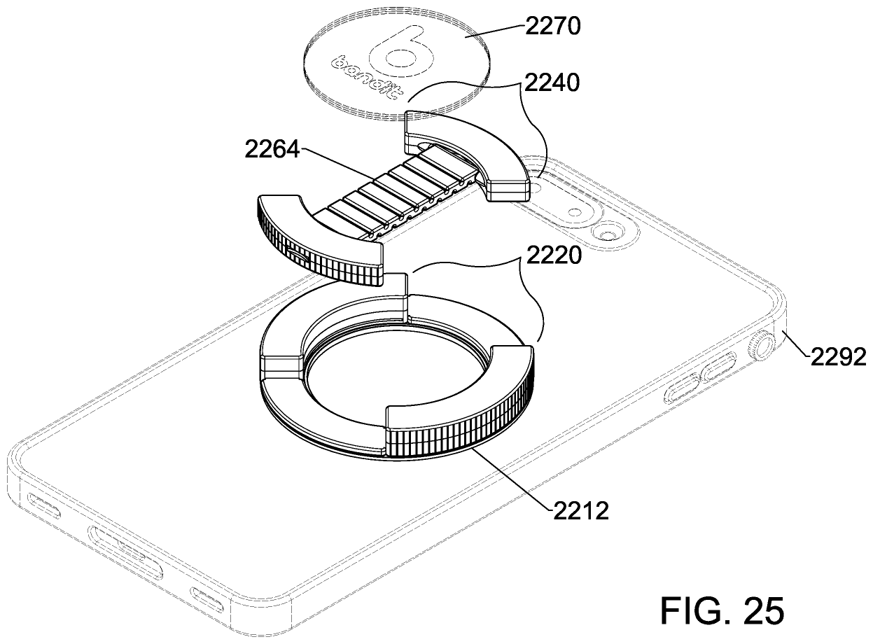

Turning now to FIG. 22 is an exploded view 2200 of another embodiment of a handle assembly. The apparatus 2200 includes three major components as shown in FIG. 23 and FIG. 25 is a reduced exploded view of FIG. 22, illustrating three major components with badge in an upper position.

The first component is a ring-shaped ferromagnetic base mount 2212. The second component is a ring-shaped magnet base 2220. The third component is a flexible strap assembly 2240.

The second component is a ring-shaped magnet base 2220 includes at least one arcuate portion 2222, 2224, 2236, 2238 with a set of two or more base magnets 2226, 2228 disposed therein as shown. The arcuate portion is made of a non-magnetic organic or inorganic material such as rubber, plastic, leather, or a combination. The base magnets 2226, 2228 magnetically couple with a portion (2214 or 2216) of the ring-shaped ferromagnetic base mount.

In one example, the ring-shaped magnet base 2220 further includes a first arcuate portion 2222, 2224 with a set of two or more base magnets 2226 disposed therein, and a second arcuate portion 2236, 2238 with a set of two or more base magnets 2228 disposed therein, and wherein the first arcuate portion 2222, 2224 and the second arcuate portion 2236, 2238 are joined together with a set of two ferromagnetic portions 2230, 2232, to form the ring-shape magnetic base.

The apparatus also includes a flexible strap assembly 2240 with a first arcuate end 2242, 2250 with a first set of two or more magnets disposed 2242 therein for magnetically coupling with a portion 2230 of the ring-shaped magnetic base 2220. The flexible strap assembly 2240 also includes a second arcuate end 2244, 2252 with a second set of two or more magnets 2248 disposed therein, for magnetically coupling with another portion 2232 of the ring-shaped magnetic base 2220. A flexible strap 2264 includes a first end 2260 fastened to the first arcuate end (2242, 2250), and a second end 2262 fastened to the second arcuate end (2244, 2252). In one example, the flexible strap 2264 is fastened to the first arcuate end (2242, 2250) and the second arcuate end (2244, 2252) with spring-loaded pins, similar to a watch band. The flexible strap 2264, like a watch strap, can be made of any flexible organic or inorganic material, including rubber, plastic, leather, or a combination thereof.

The based magnets 2226, 2228 and the first set of magnets 2242, and the second set of magnets 2248 are permanent magnets made from neodymium magnet material. Other types of permanent magnets that are applicable are magnetic metallic elements, rare-earth magnets, composite magnets, nano-structured magnets or a combination thereof. The magnets 2226, 2228, 2242, 2248 may be positioned in an alternating opposing magnetic pole pattern. A north pole type may face upward for one magnet adjacent to a south pole type facing up for an adjacent magnet. Further, the magnets 2226, 2228, 2242, 2248 may be disk-shaped magnets, cylindrical-shaped magnets, or a combination of both.

In another example, the magnets 2226, 2228, 2242, 2248 may include groups of a plurality of magnets stacked one-on-top of another so that a first magnetic pole type of one of the stacked magnets sits on top of a second magnetic pole type of another of the stacked magnets.

An optional badge or cap 2270 covers the flexible strap 2264 in the opening defined between the first arcuate end 2242, 2250, and the second arcuate end 2244, 2252 as shown. The cap or cover may be clear or, in another example, include custom graphics and colors, such as sports logos, names, or other personalized graphics.

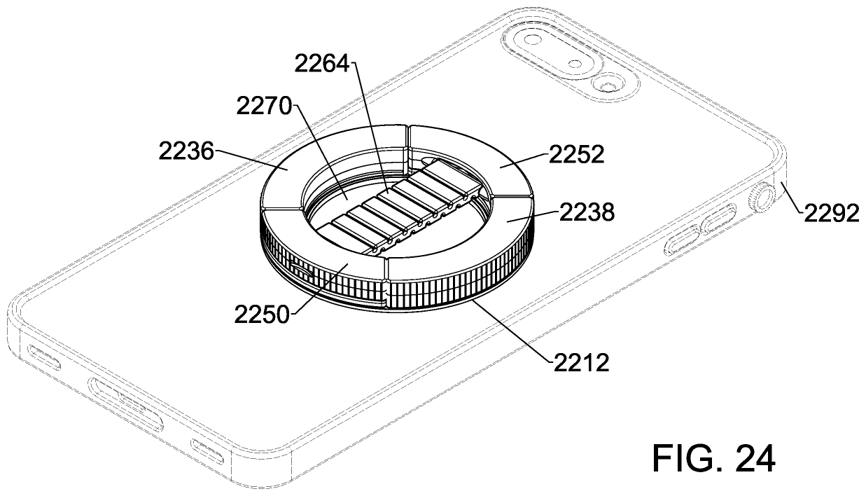

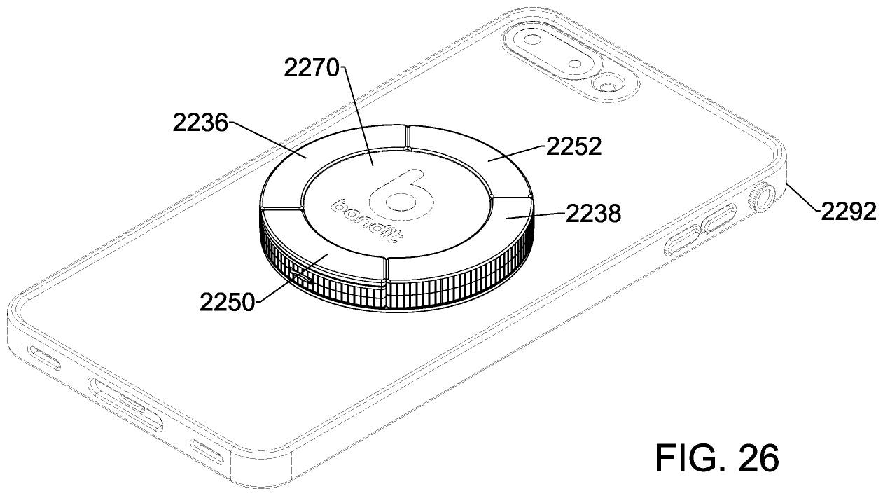

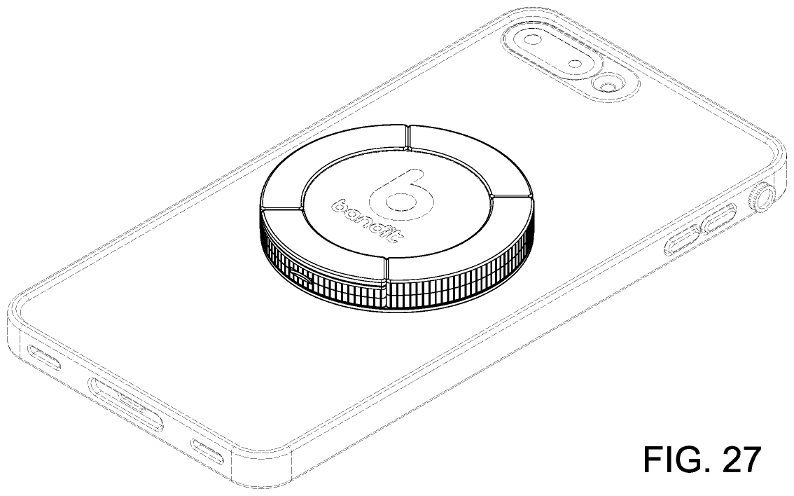

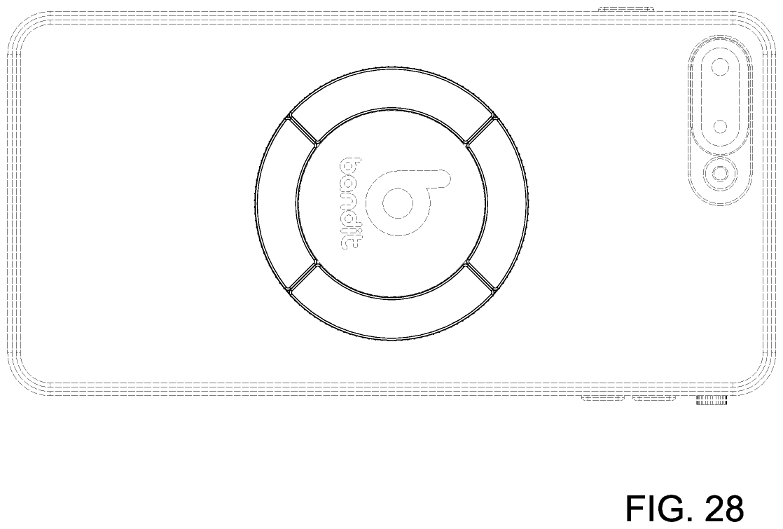

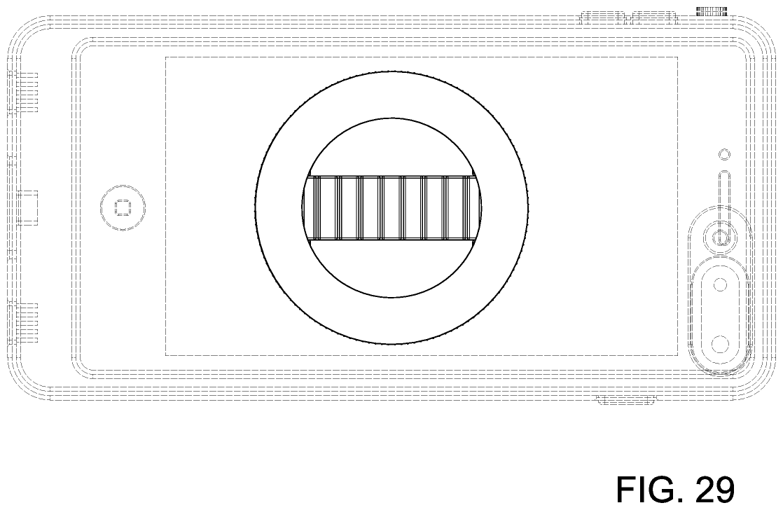

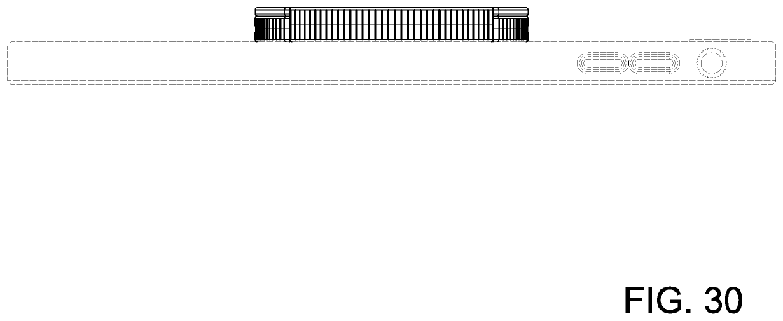

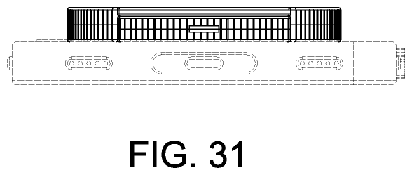

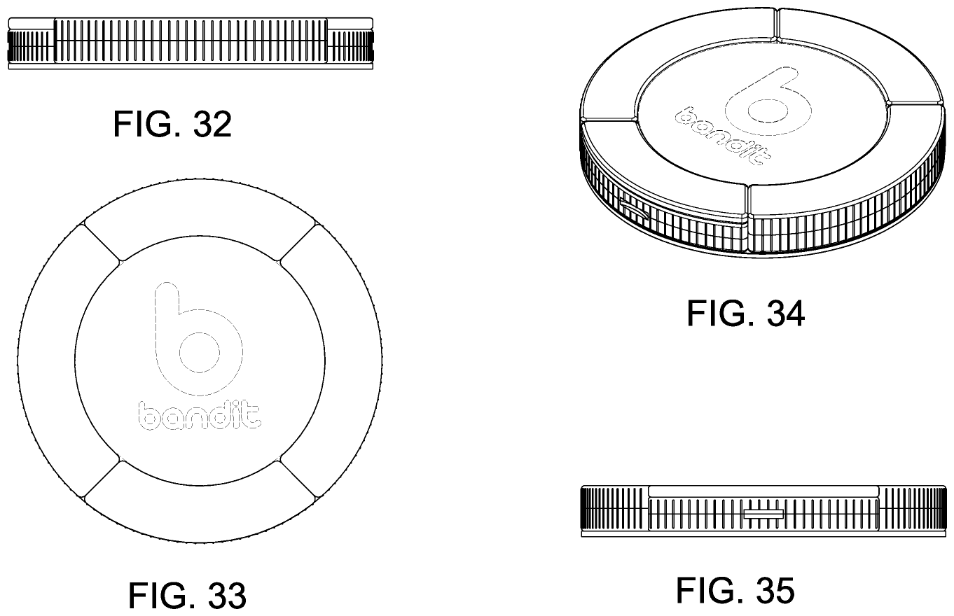

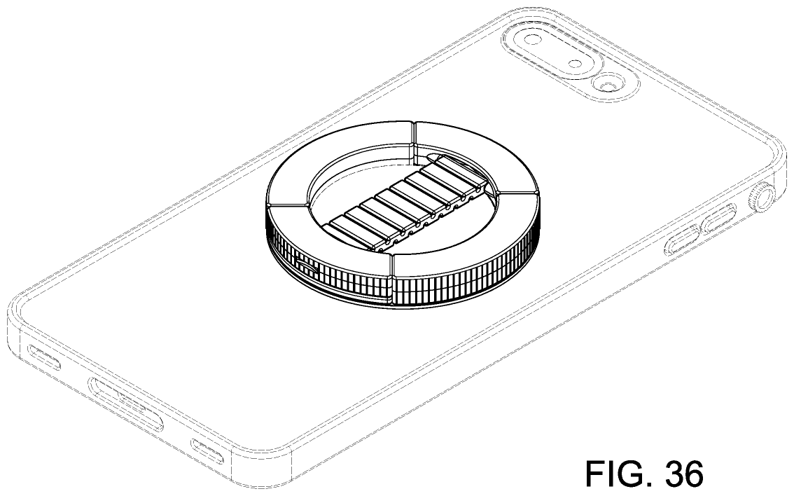

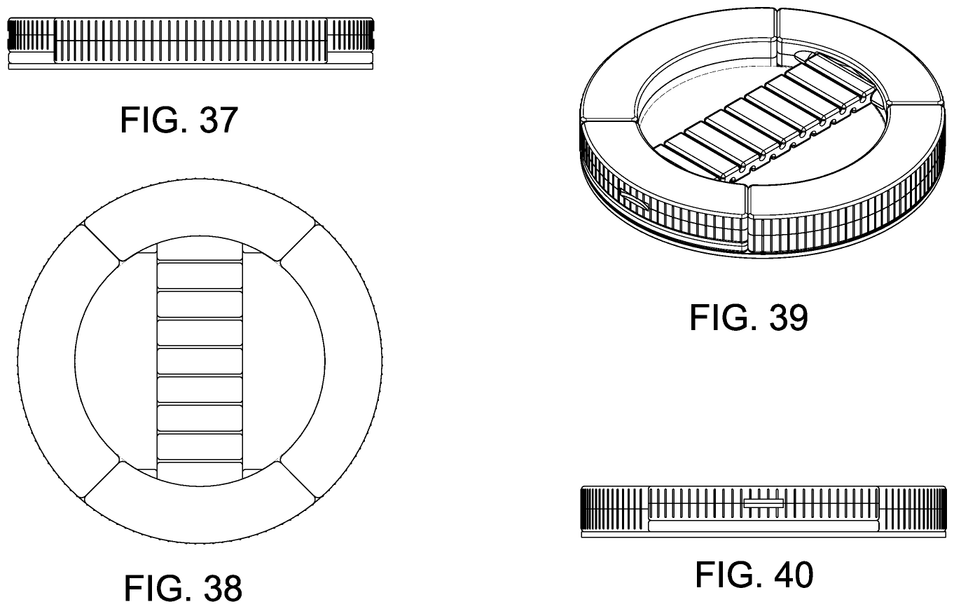

FIG. 24 is an assembled view of FIG. 22, with the badge 2270 in a lower position. In this position, the flexible strap assembly 2240 is rotated 180 degrees about an axes parallel to the flexible strap 2264. In this position, the badge 2270 is positioned beneath the flexible strap 2264 as shown. This ability to rotate the flexible strap assembly 2240 allows the badge to be stored out of the way while a user's finger or fingers is placed underneath the flexible strap 2264. FIG. 26 is an assembled view of FIG. 22, with the badge in an upper position.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A handheld electronic device holding apparatus comprising:
a ring-shaped ferromagnetic base mount;
a ring-shaped magnet base with at least one arcuate portion with a set of two or more base magnets disposed therein, for magnetically coupling with a portion of the ring-shaped ferromagnetic base mount; and
a flexible strap assembly with a first arcuate end with a first set of two or more magnets disposed therein for magnetically coupling with a portion of the ring-shaped magnetic base and a second arcuate end with a second set of two or more magnets disposed therein, for magnetically coupling with another portion of the ring-shaped magnetic base, and a flexible strap with a first end fastened to the first arcuate end and a second send fastened to the second arcuate end.

2. The handheld electronic device holding apparatus of claim 1, wherein the ring-shaped magnet base further includes a first arcuate portion with a set of two or more base magnets disposed therein, and a second arcuate portion with a set of two or more base magnets disposed therein, and wherein the first arcuate portion and the second arcuate portion are joined together with a set of two ferromagnetic portions to form the ring-shape magnetic base.

3. The handheld electronic device holding apparatus of claim 1, wherein flexible strap further comprises:
a band with a first end with a first opening and a second end with a second opening; and
a first spring loaded pin placed inside the first opening for joining the band to the first end of the flexible strap and a second spring loaded pin placed inside the second opening for joining the band to second end of the flexible strap.

4. The handheld electronic device holding apparatus of claim 1, further comprising a cap for releasably engaging a cavity formed between the first arcuate end and the second arcuate end and over the flexible strap.

5. The handheld electronic device holding apparatus of claim 1, wherein the set of two or more base magnets are positioned in an alternating magnetic pole pattern.

6. The handheld electronic device holding apparatus of claim 1, wherein the set of two or more base magnets are disk-shaped magnets, cylindrical-shaped magnets, or a combination of both.

7. The handheld electronic device holding apparatus of claim 6, wherein the set of two or more base magnets include groups of a plurality of magnets stacked one-on-top of another, so that a first magnetic pole type of one of the stacked magnets sits on top of a second magnetic pole type of another of the stacked magnets.

8. The handheld electronic device holding apparatus of claim 7, wherein the set of two or more base magnets is positioned in an alternating magnetic pole pattern.

9. The handheld electronic device holding apparatus of claim 1, wherein the at least one arcuate portion of the ring-shaped magnet base is formed from a bottom plastic portion and a top plastic portion with the base magnets disposed therebetween.

10. The handheld electronic device holding apparatus of claim 1, wherein the first set of two or more magnets in the first arcuate end and the second set of two or more magnets in the second arcuate end are positioned in an alternating magnetic pole pattern.

11. The handheld electronic device holding apparatus of claim 1, wherein the first set of two or more magnets in the first arcuate end of the flexible strap assembly and the second set of two or more magnets in the second arcuate end of the flexible strap assembly are disk-shaped magnets, cylindrical-shaped magnets, or a combination of both.

12. The handheld electronic device holding apparatus of claim 11, wherein the first set of two or more magnets in the first arcuate end and the second set of two or more magnets in the second arcuate end are positioned in an alternating magnetic pole pattern.

13. The handheld electronic device holding apparatus of claim 1, wherein the first set of two or more magnets in the first arcuate end and the second set of two or more magnets in the second arcuate end include groups of a plurality of magnets stacked one-on-top of another, so that a first magnetic pole type of one of the stacked magnets sits on top of a second magnetic pole type of another of the stacked magnets.

14. The handheld electronic device holding apparatus of claim 13, wherein the first set of two or more magnets in the first arcuate end and the second set of two or more magnets in the second arcuate end are positioned in an alternating magnetic pole pattern.

15. The handheld electronic device holding apparatus of claim 1, wherein the first arcuate end of the flexible strap assembly is formed from a bottom plastic portion and a top plastic portion with the first set of magnets disposed therebetween.

16. The handheld electronic device holding apparatus of claim 15, wherein the second arcuate end of the flexible strap assembly is formed from a bottom plastic portion and a top plastic portion with the second set of magnets disposed therebetween.
